(19) United States
(12) Patent Application Publication
(10) Pub. No.: US 2006/0034217 A1
(43) Pub. Date: Feb. 16, 2006

(54) Method and network device for enabling MIMO station and SISO station to coexist in wireless network without data collision

(75) Inventors: Chang-yeul Kwon, Seongnam-si (KR); Chil-youl Yang, Yongin-si (KR); Se-young Shin, Suwon-si (KR); Suk-jin Yun, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/201,388

(22) Filed: Aug. 11, 2005

(30) Foreign Application Priority Data
Aug. 11, 2004 (KR) 10-2004-0063199

(51) Int. Cl. H04Q 7/00

(52) U.S. Cl. 370/328

(57) ABSTRACT

Provided are a method of enabling a multi-input multi-output (MIMO) station and a single input single output (SISO) station to coexist in a wireless network and a wireless network device. The method includes receiving information on a station when the station accesses a wireless network, setting coexistence information by comparing a number of antennas of the station accessing the wireless network with a number of antennas of a plurality of stations constituting the wireless network, and transmitting a frame containing the coexistence information to the plurality of stations constituting the wireless network.

### CROSS-REFERENCE TO RELATED APPLICATION

This application claims priority from Korean Patent Application No. 10-2004-0063199 filed on Aug. 11, 2004 in the Korean Intellectual Property Office, the disclosure of which is incorporated herein by reference in its entirety.

### BACKGROUND OF THE INVENTION

1. Field of the Invention

Apparatuses and methods consistent with the present invention relate to enabling a multiple input multiple output (MIMO) station and a single input single output (SISO) station to coexist in a wireless network without colliding with each other.

2. Description of the Related Art

There is an increasing demand for ultra high-speed communication networks due to widespread public use of the Internet and a rapid increase in the amount of available multimedia data. Since the local area network (LAN) emerged in the late 1980s, the data transmission rate has drastically increased from about 1 Mbps to about 100 Mbps. Thus, high-speed Ethernet transmission has gained popularity and wide spread use. Currently, intensive research into gigabit speed Ethernet is under way. An increasing interest in wireless networks has triggered research into and development of a wireless local area network (WLAN), greatly increasing the availability of WLANs to consumers. Although WLANs have lower transmission rates and poorer stability than wired LANs, WLANs have various advantages, including wireless networking capability and greater mobility. Accordingly, WLAN markets have been gradually growing.

Due to the need for a greater transmission rate and the development of wireless transmission technology, the initial IEEE 802.11 standard, which specifies a 1-2 Mbps transfer rate, has evolved into advanced standards including 802.11b and 802.11a. Currently, the new IEEE standard, 802.11g, is being discussed by the Standardization Conference groups. The IEEE 802.11g standard delivers a 6-54 Mbps transmission rate in the 56 GHz-National Information Infrastructure (NII) band and uses orthogonal frequency division multiplexing (OFDM). With an increasing public interest in OFDM and use of the 5 GHz band, much greater attention is being paid to OFDM than other wireless standards.

Recently, a wireless Internet service called “Nespot” has been offered by the Korea Telecommunication (KT) Corporation. Nespot services allow access to the Internet using a WLAN according to IEEE 802.11b, commonly called Wi-Fi (Wireless Fidelity). Communication standards for wireless data communication systems, which have been completed and promulgated or are under research and discussion, include WCDMA (Wide Code Division Multiple Access), IEEE 802.11x, Bluetooth, and IEEE 802.15.3, which are known as 3G (3rd Generation) communication standards. The most widely known and cheapest wireless data communication standard is IEEE 802.11b, which is a series of IEEE 802.11x. The IEEE 802.11b WLAN standard delivers data transmission at a maximum rate of 11 Mbps and utilizes the 2.4 GHz Industrial-Scientific-Medical (ISM) band, which can be used below a predetermined electric field without permission. With the recent widespread use of the IEEE 802.11a WLAN standard, which delivers a maximum data rate of 54 Mbps in the 5 GHz band by using OFDM, IEEE 802.11g, which developed as an extension the IEEE 802.11a for data transmission in the 2.4 GHz band using OFDM, is being intensively researched.

Ethernet and WLAN, which are currently being widely used, both utilize a carrier sensing multiple access (CSMA) method. According to the CSMA method, it is determined whether a channel is in use. If the channel is not in use, that is, if the channel is idle, then data is transmitted. If the channel is busy, retransmission of data is attempted after a predetermined period of time. A carrier sensing multiple access with collision detection (CSMA/CD) method, which is an improvement of the CSMA method, is used in a wired LAN, whereas a carrier sensing multiple access with collision avoidance (CSMA/CA) method is used in packet-based wireless data communications. In the CSMA/CD method, a station suspends transmitting signals if a collision is detected during transmission. The CSMA method pre-checks whether a channel is occupied before transmitting data, but in the CSMA/CD method the station suspends transmission of signals when a collision is detected during transmission and it transmits a jam signal to another station to inform it of the collision. After the transmission of the jam signal, the station has a random backoff period for delay and restarts transmitting signals. In the CSMA/CD method, the station does not transmit data immediately after the channel becomes idle because it waits a random backoff period before transmitting to avoid signal collisions. If a collision occurs during transmission, the duration of the random backoff period is doubled, thereby further lowering the probability of collision.

Wireless communication methods are classified as single input single output (SISO) method, single input multiple output (SIMO), or multiple input multiple output (MIMO) depending on the number of antennas used to receive and transmit data. The SISO system is a data transmission method using one antenna to both receive and transmit data, and the SIMO system is a data transmission method using one antenna to transmit data but using a plurality of antennas to receive data, and thus, it ensures signal reception.

The MIMO system is one type of adaptive array antenna technology that electrically controls directivity using a plurality of antennas. Specifically, in the MIMO system, directivity is enhanced using a plurality of antennas by narrowing beamwidth, thereby forming a plurality of transmission paths that are independent from one another. Accordingly, the data transmission speed of a device that adopts the MIMO system increases as many times as there are antennas in the MIMO device. The MIMO system is further classified into a spatial multiplexing method, which can transmit data at high speed by transmitting different data via multiple antennas at the same time without increasing the bandwidth of the MIMO device, or a spatial diversity method, which can ensure transmission versatility by transmitting the same data via multiple antennas.

FIG. 1 is a diagram illustrating the operation of a station that transmits or receives data in the MIMO system. Referring to FIG. 1, in operation S10, a wireless network device 10 transmits data to a MIMO encoder 52 at a rate of 108 Mbit/sec. In operation S20, the MIMO encoder 52 encodes the data transmitted by the wireless network device 10 and then transmits the encoded data at a rate of 54 Mbit/sec to a MIMO transmitter 54. In operation S30, the MIMO transmitter 54 transmits the encoded data via two antennas. In operation S40, a MIMO receiver 56 receives the data transmitted by the MIMO transmitter 54 via a wireless multipath channel. In operation S50, the MIMO receiver 56 recombines the received data and then transmits the recombined data to an access point (AP) 900 at a rate of 108 Mbit/sec.

Currently, more public attention is being drawn to the MIMO system because of the fact that the MIMO system can enhance data transmission speed. The MIMO system is being considered as a leading data transmission technique used in an 802.11n wireless network and is also considered as being capable of enhancing data transmission speed in an existing 802.11 wireless network, such as an 802.11a, an 802.11b, or an 802.11g wireless network. However, there is a high probability that a conventional wireless network device and a MIMO wireless network device will collide with each other when they coexist in an 802.11a, an 802.11b, or an 802.11g wireless network. Thus, it is necessary to prevent collisions between a conventional wireless network device and a MIMO wireless network device when they coexist in such wireless network. It is possible to prevent collisions between a conventional wireless network device and a MIMO wireless network device by modifying the conventional wireless network protocol. However, the modified conventional wireless network protocol cannot be applied to network devices manufactured beforehand. Thus, from economic and technical viewpoints, modification of the conventional wireless network protocol is not desirable. A conventional method of enabling a plurality of stations adopting different data transmission modes to coexist in a network by allowing the stations to transmit data at different times is disclosed in U.S. Patent Published Application No. 2003-0169763. Specifically, in the disclosed technology, two stations adopting different modulation methods, i.e., an 802.11b station and an 802.11g station, can coexist in a network and transmit data at different times. In other words, the 802.11g station can transmit data in a contention-free mode and the 802.11b station can transmit data in a contention mode. However, as the amount of data transmitted by the 802.11g station and the 802.11b station decreases, the amount of time given to the 802.11g station and the 802.11b stations becomes smaller, and thus, the data transmission efficiency of the 802.11g station and the 802.11 stations is lowered.

Therefore, it is necessary to develop a method of enabling a conventional wireless network device and a MIMO wireless network device to coexist in a network without modifying the structure of the conventional wireless network device.

### SUMMARY OF THE INVENTION

The present invention provides a technique of enabling a multi-input multi-output (MIMO) station and a single input single output (SISO) station to coexist in a network without colliding with each other.

The present invention also provides a technique of preventing a SISO station from transmitting data when a MIMO station transmits data.

The above stated objects as well as other objects, features and advantages, of the present invention will become clear to those skilled in the art upon review of the following description.

According to an aspect of the present invention, there is provided a method of enabling a multi-input multi-output (MIMO) station and a single input single output (SISO) station to coexist in a wireless network, the method including receiving information pertaining to a station when the station accesses a wireless network, setting coexistence information by comparing a number of antennas of the station accessing the wireless network with a number of antennas of a plurality of stations constituting the wireless network, and transmitting a first frame containing the coexistence information to the plurality of stations constituting the wireless network.

According to another aspect of the present invention, there is provided a method of enabling a MIMO station and a SISO station to coexist in a wireless network, the method including allowing a first MIMO station among a plurality of stations constituting a wireless network to receive a first frame containing coexistence information of other stations among the plurality of stations constituting the wireless network, allowing the first MIMO station to transmit a second frame whose destination is the first MIMO station in a SISO system if the coexistence information indicates that at least one station among the plurality of stations is a SISO station, and allowing the first MIMO station to transmit MIMO data to a second MIMO station, among the plurality of stations, in a MIMO system.

According to still another aspect of the present invention, there is provided a method of enabling a MIMO station and a SISO station to coexist in a wireless network, the method including allowing a first MIMO station among a plurality of stations constituting a wireless network to receive a first frame containing coexistence information of other stations among the plurality of stations constituting the wireless network, allowing the first MIMO station to transmit a second frame to a second MIMO station among the plurality of stations in a SISO system if the coexistence information indicates that at least one station among the plurality of stations is a SISO station, allowing the first MIMO station to receive a third frame transmitted in the SISO system by the second MIMO station, and allowing the first MIMO station to transmit MIMO data to the second MIMO station in a MIMO system.

According to a further aspect of the present invention, there is provided a network device including a receiving unit, which receives information pertaining to a station when the station accesses a wireless network, a coexistence information setting unit, which sets coexistence information by comparing a number of antennas of the station accessing the wireless network with a number of antennas of a plurality of stations constituting the wireless network and stores the coexistence information, and a transmitting unit, which transmits a first frame containing the coexistence information to the plurality of stations constituting the wireless network.

According to yet another aspect of the present invention, there is provided a network device including a receiving unit, which receives, from a wireless network, a first frame containing coexistence information pertaining to a plurality of stations constituting the wireless network, and a coexistence information setting unit, which stores the coexistence information contained in the received first frame, and a transmitting unit, which transmits a second frame to a MIMO station of the plurality of stations in a SISO system if the coexistence information contained in the first frame indicates that at least one station of the plurality of stations is a SISO station, and wherein a destination of the second frame is the network device.

According to another aspect of the present invention, there is provided a network device including a receiving unit, which receives, from a wireless network, a first frame containing coexistence information pertaining to a plurality of stations constituting the wireless network, and a transmitting unit, which transmits a second frame to a MIMO station of the plurality of stations in a SISO system if the coexistence information contained in the received first frame indicates that at least one station of the plurality of stations is a SISO station, wherein the receiving unit receives a third frame transmitted by the MIMO station and the transmitting unit transmits data to the MIMO station in a MIMO system.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating the operation of a station that transmits or receives data in a multiple input multiple output (MIMO) system;

FIG. 2 is a diagram illustrating a wireless network where a plurality of 802.11a stations and a MIMO station coexist;

FIG. 3 is a sequence diagram illustrating a method of transmitting data between single input single output (SISO) stations and MIMO stations without collisions therebetween according to an exemplary embodiment of the present invention; and

FIG. 4A is a diagram illustrating the structure of a coexistence parameter set according to an exemplary embodiment of the present invention;

FIG. 4B is a table illustrating the identifiers of a plurality of information elements including a coexistence parameter set according to an exemplary embodiment of the present invention;

FIG. 5 is a diagram illustrating a coexistence mechanism according to an exemplary embodiment of the present invention;

FIG. 6 is a diagram illustrating a coexistence mechanism according to another exemplary embodiment of the present invention;

FIGS. 7A and 7B are diagrams illustrating the structures of networks according to exemplary embodiments of the present invention;

FIG. 8 is a diagram illustrating the modifying of a coexistence parameter set according to an exemplary embodiment of the present invention in consideration of a network environment and the sending of the modified coexistence parameter set;

FIG. 9 is a diagram illustrating the modifying of a coexistence parameter set according to an exemplary embodiment of the present invention in consideration of a network environment and the sending of the modified coexistence parameter set; and

FIG. 10 is a block diagram illustrating a MIMO station according to an exemplary embodiment of the present invention.

### DETAILED DESCRIPTION OF ILLUSTRATIVE, NON-LIMITING EMBODIMENTS OF THE INVENTION

The present invention will now be described more fully with reference to the accompanying drawings, in which exemplary embodiments of the invention are shown.

In describing the exemplary embodiments, certain terminology will be utilized for the sake of clarity.

RTS & CTS

A Request to Send (RTS) frame is used for securing a medium for large-sized frame transmission. A Clear to Send (CTS) frame is a response to the RTS frame.

Short Interframe Space (SIFS)

A SIFS is used for transmitting a highly prioritized frame, such as an RTS, a CTS, or a positive acknowledgement frame. Such highly prioritized frames can be transmitted after a SIFS.

Network Allocation Vector (NAV)

A NAV is a value set for preventing data transmitted between devices in a wireless network from colliding with each other. The NAV is set based on values contained in an RTS frame, a CTS frame, or other frames transmitted between devices in the wireless network. A medium is assumed to be busy when the NAV is non-zero. Therefore, unless the NAV is 0, devices, other than devices currently transmitting data using the medium, are not allowed to transmit data.

Stations

Stations are devices that wirelessly transmit data or wirelessly receive data from other devices in a wireless network. Stations may be computing devices, such as laptop computers, personal digital assistants (PDAs), or personal computers (PCs), or they may be other types of devices. Stations may also be portable devices, or fixed devices that can communicate with each other in a wireless communication environment. Therefore, devices that can wirelessly communicate with one another in a wireless network will now be referred to as stations.

Beacon Frame

A beacon frame announces the existence of a network and plays an important part in the maintenance and management of the network. That is, the beacon frame enables a mobile station to join the network by specifying parameters which can be used with the mobile station which wants to join the network, and the beacon frame is periodically transmitted for locating or recognizing the network. The beacon frame includes various types of information fields.

Probe Response Frame

A probe response frame is a response to a probe request frame that is issued for requesting network information. The probe response frame contains the requested network information. A mobile station can join a network by analyzing the parameters of a beacon frame transmitted via a probe response frame.

Multi-input multi-output (MIMO) & Single Input Single Output

(SISO)

SISO indicates a method of transmitting and receiving data using a single antenna, and MIMO indicates a method of transmitting and receiving data using a plurality of antennas. An example of the SISO system is an 802.11a or an 802.11b system. A station supporting the SISO system (hereinafter referred to as a SISO station) cannot perceive data transmitted in the MIMO system by a station supporting the MIMO system (hereinafter referred to as a MIMO station) but it can perceive data transmitted in the SISO system by the MIMO station.

The present invention will now be described in detail taking the 802.11a standard as an example of a wireless communication standard for SISO stations. However, the present invention is not restricted to the 802.11a standard.

A method of preventing data collision in a wireless network can be classified into a physical carrier sensing method or a virtual carrier sensing method. In the physical carrier sensing method, it is determined whether a wireless medium is in use by a station, and thus, stations other than the station using the wireless medium are prevented from attempting to transmit data using the wireless medium, thereby preventing data collisions. In the virtual carrier sensing method, a special value called a NAV is needed. Specifically, unless the NAV has a value of 0, it is assumed that a wireless medium is being used by a station, and thus, stations other than the station currently using the wireless medium are prevented from attempting to transmit data using the wireless medium. A NAV value can be set by calculating the amount of time necessary to transmit a predetermined frame, such as an RTS or a CTS frame.

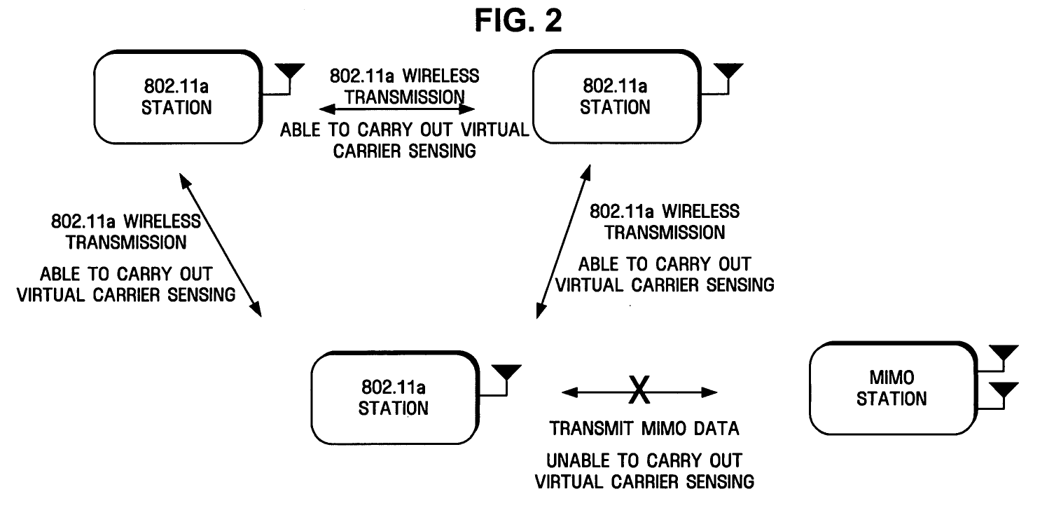

FIG. 2 is a diagram illustrating a wireless network where a plurality of 802.11a stations and a MIMO station coexist. Referring to FIG. 2, the 802.11a stations can be prevented from colliding with one another by using the virtual carrier sensing method. However, since the MIMO station transmits data in the MIMO system, the data transmitted by the MIMO station cannot be perceived by the 802.11a stations. Accordingly, the 802.11a stations cannot set their respective NAV values or they cannot determine what data is currently being transmitted by the MIMO station. Thus, the 802.11a stations may attempt to transmit data even when they fail to recognize the data transmitted by the MIMO station using the virtual carrier sensing method, and data collisions occur as a result. This phenomenon has been an obstacle to the coexistence of SISO stations and MIMO stations, and thus, it is necessary to develop a method of transmitting data between a SISO station and a MIMO station without collisions therebetween.

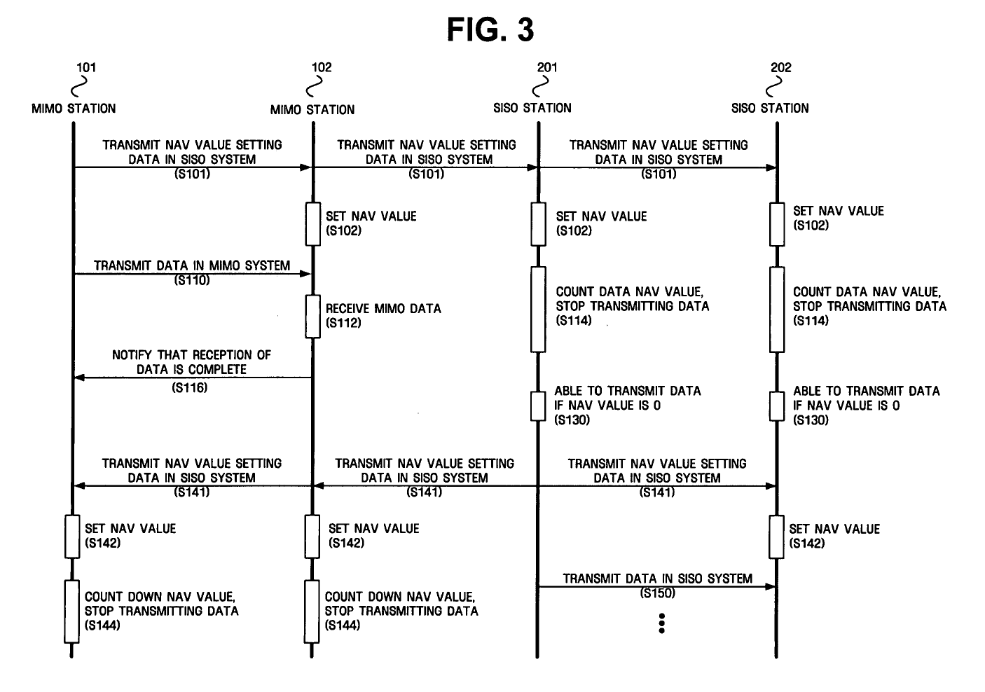

FIG. 3 is a sequence diagram illustrating a method of transmitting data between SISO stations and MIMO stations without collisions therebetween according to an exemplary embodiment of the present invention.

Referring to FIG. 3, a wireless network includes two MIMO stations, i.e., first and second MIMO stations 101 and 102, and two SISO stations, i.e., first and second SISO stations 201 and 202. The number of MIMO stations and SISO stations included in the wireless network, however, are exemplary, and thus, the present invention is not restricted thereto. The first and second SISO stations 201 and 202 may be 802.11a, 802.11b, or 802.11g wireless network devices.

In operation S101, before transmitting data to the second MIMO station 102, the first MIMO station 101 transmits NAV value setting data in a SISO system, and particularly, in an 802.11a, 802.11b, or 802.11g system, so that the other stations, i.e., the second MIMO station 102 and the first and second SISO stations 201 and 202, can carry out a virtual carrier sensing operation to prevent data collisions therebetween. The NAV value setting data transmitted in the SISO system by the first MIMO station 101 can be recognized by the second MIMO station 102 and the first and second SISO stations 201 and 202.

In operation S102, the second MIMO station 102 and the first and second SISO stations 201 and 202 sets their respective NAV values based on the NAV value setting data received from the first MIMO station 101. In operation S110, the first MIMO station 101 transmits data in a MIMO system. In operation S112, the second MIMO station 102 receives the data transmitted by the first MIMO station 101. Since the first and second SISO stations 201 and 202 set their respective NAV values based on the data received from the first MIMO station 101, they can recognize that a channel is in use even though they do not recognize the data transmitted in the MIMO system by the first MIMO station 101. Thus, in operation S114, the first and second SISO stations 201 and 202 stop transmitting data until their respective NAV values are 0. In operation S116, when the second MIMO station 102 receives all of the data transmitted in the MIMO system by the first MIMO station 101, it notifies the first MIMO station 101 that the reception is complete. In operation S130, the first and second SISO stations 201 and 202 can transmit data once they recognize that the channel is free based on their respective NAV values. In operation S141, the first SISO station 201 transmits NAV value setting data needed in a virtual carrier sensing operation in the SISO system before transmitting data to the second SISO station 202. In operation S142, the first and second MIMO stations 101 and 102 and the second SISO station 202 receive the NAV value setting data transmitted by the first SISO station 201, set their respective NAV values based on the received NAV value setting data, and assume that the channel is currently used until their respective NAV values are counted down to 0. In operation S144, the first and second MIMO stations 101 and 102 and the second SISO station 202 count down their respective NAV values. In operation S150, the first SISO station 201 transmits data to the second SISO station 202.

In short, it is possible to prevent data collisions among the first and second MIMO stations 101 and 102 and the first and second SISO stations 201 and 202 by carrying out a virtual carrier sensing operation before each of the first and second MIMO stations 101 and 102 and the first and second SISO stations 201 and 202 attempt to transmit data, as illustrated in FIG. 3.

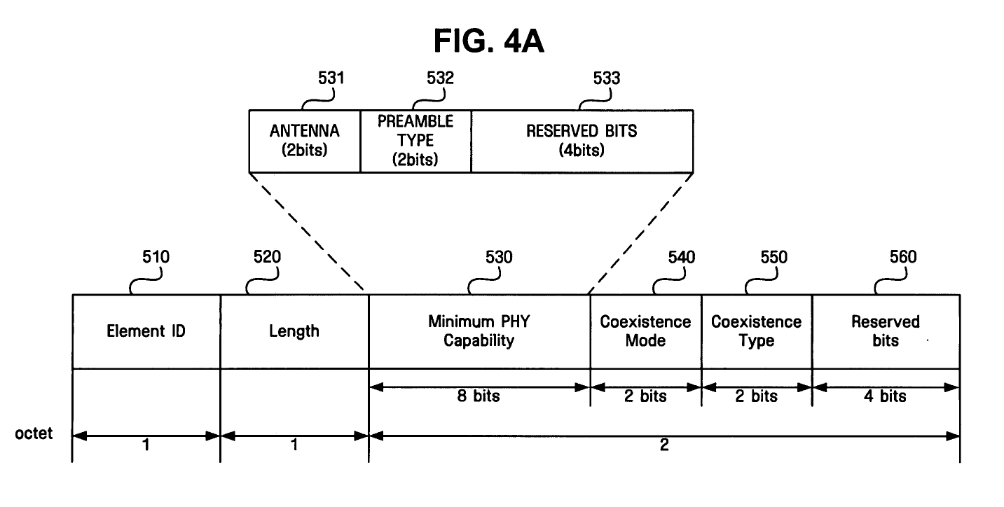

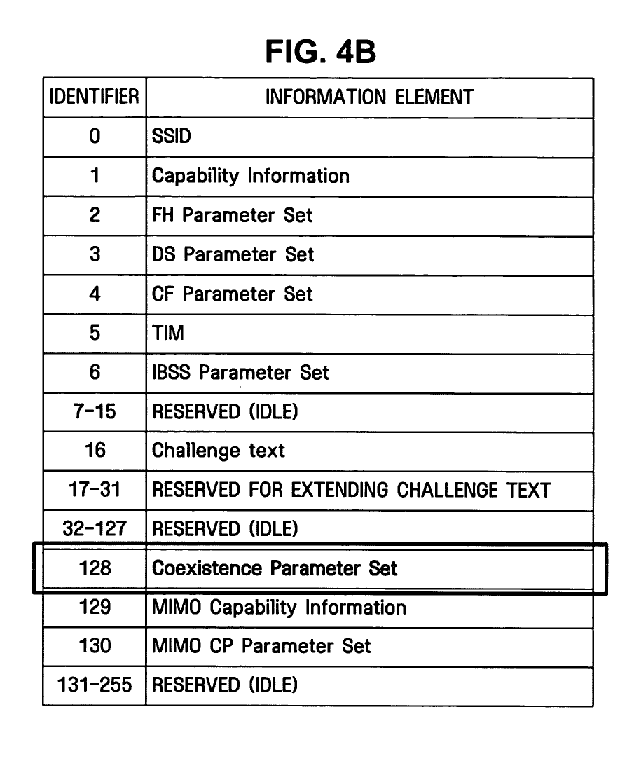

FIG. 4A is a diagram illustrating the structure of a coexistence parameter set according to an exemplary embodiment of the present invention. Referring to FIG. 4A, the coexistence parameter set is an information element that prevents data collisions between stations adopting different data transmission methods in a wireless network. The coexistence parameter set may be included in a beacon frame or a probe response frame and then transmitted to all of the stations in the wireless network. The coexistence parameter set includes an element identifier (ID) field 510, a length field 520, a minimum physical layer (PHY) capability field 530, a coexistence mode field 540, a coexistence type field 550, and a reserved bits field 560.

The element ID field 510 identifies the coexistence parameter set and is comprised of 8 bits (i.e., one octet). A beacon frame or a probe response frame may be transmitted carrying a plurality of information elements containing a variety of information. Accordingly, identifiers (illustrated in FIG. 4B) may be used to differentiate the information elements.

FIG. 4B is a table illustrating the identifiers of a plurality of information elements including a coexistence parameter set according to an exemplary embodiment of the present invention. Referring to FIG. 4B, identifiers 7 through 15, 32 through 128, and 131 through 255 are yet to be allotted to information elements, and thus, one of them can be allotted to the coexistence parameter set. Since identifiers 129 and 130 are allotted to MIMO related information, identifier 128 can be allotted to the coexistence parameter set. However, one of identifiers 7 through 15, 32 through 128, and 131 through 255, other than identifier 128, can be allotted to the coexistence parameter set.

The length field 520 specifies the length of the coexistence parameter set.

The minimum PHY capability field 530 specifies the capability of a physical layer of each of a plurality of stations in a wireless network. The minimum PHY capability field 530 is comprised of three sub-fields, i.e., an antenna sub-field 531, a preamble type sub-field 532, and a reserved bits sub-field 533.

The antenna sub-field 531 specifies a minimum number of antennas of the stations in the wireless network. If SISO stations and MIMO stations coexist in the wireless network, the antenna sub-field 531 may be set to a value of 1 because the SISO stations have only one antenna. However, if there are only MIMO stations in the wireless network, the antenna sub-field 531 may be set to a value of 2 or greater. The antenna sub-field 531 can be extended with or without using bits of the reserved bits sub-field 533 when the performance of the stations in the wireless network device improves.

The preamble type sub-field 532 specifies the type of preamble the coexistence parameter set uses, for example, whether the preamble used by the coexistence parameter set is an 802.11a preamble or a MIMO preamble. The reserved bits sub-field 533 is a portion reserved for extending the minimum PHY capability field 530.

In the case where MIMO stations and SISO stations coexist in the wireless network, the coexistence mode field 540 specifies whether to selectively or indiscriminately apply a coexistence mechanism, such as the coexistence mechanism illustrated in FIG. 3, to the wireless network or the coexistence mode field 540 specifies whether to allow each of the stations in the wireless network to decide whether to use the coexistence mechanism. In other words, the coexistence mode field 540 contains information concerning whether to use the coexistence mechanism.

In a ‘don't care’mode, which is set to a value of ‘00’, the stations in the wireless network are allowed to decide whether to use a coexistence mechanism. Accordingly, the stations in the wireless network determine whether to use a coexistence mechanism with reference to the minimum PHY capability field 530 and then transmit or receive data based on the determination results. The ‘don't care’ mode means nonintervention, or laissez-faire, i.e., in this mode, each station can decide whether to use a coexistence mechanism.

In a forced mode, which corresponds to a value of ‘01’, all of the stations in the wireless network are forced to use the coexistence mechanism specified in the coexistence type field 550.

In a recommended mode, which corresponds to a value of ‘10’, the stations in the wireless network are merely recommended to use the coexistence mechanism. Thus, the stations in the wireless network are simply recommended to use a coexistence mechanism to prevent data collisions therebetween unless circumstances prevent them from using the coexistence mechanism.

In a ‘don't use’ mode, which corresponds to a value of ‘11’, none of the stations in the wireless network use a coexistence mechanism. The coexistence mode field 540 may be set to a value of ‘11’ even when the stations in the wireless network, including SISO stations, decide not to use a coexistence mechanism.

The coexistence type field 550 specifies the type of coexistence mechanism to be used in the wireless network. A coexistence mechanism is a method of enabling stations adopting different data transmission systems to coexist in a wireless network. The coexistence type field 550 may be set to a value of ‘00’, ‘01’, or ‘10’, which determines which coexistence mechanism to use in the wireless network.

If the coexistence type field 550 has a value of ‘00’, the current coexistence mode is the ‘don't care’ mode, so the stations in the wireless network can choose and then use any type of coexistence mechanism.

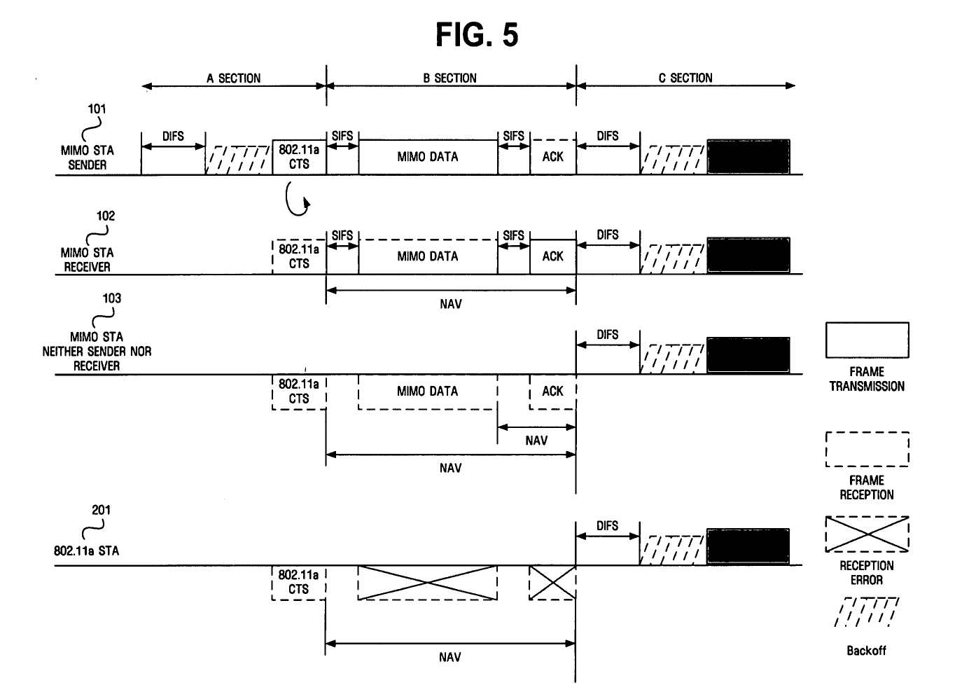

If the coexistence type field 550 has a value of ‘01’, the coexistence mechanism to be used in the wireless network is the common CTS mechanism. According to the common CTS mechanism, a CTS frame is transmitted to the wireless network before transmitting data from one station to another, so other stations can set their respective NAV values based on the CTS frame. The common CTS mechanism will be described later in detail with reference to FIG. 5.

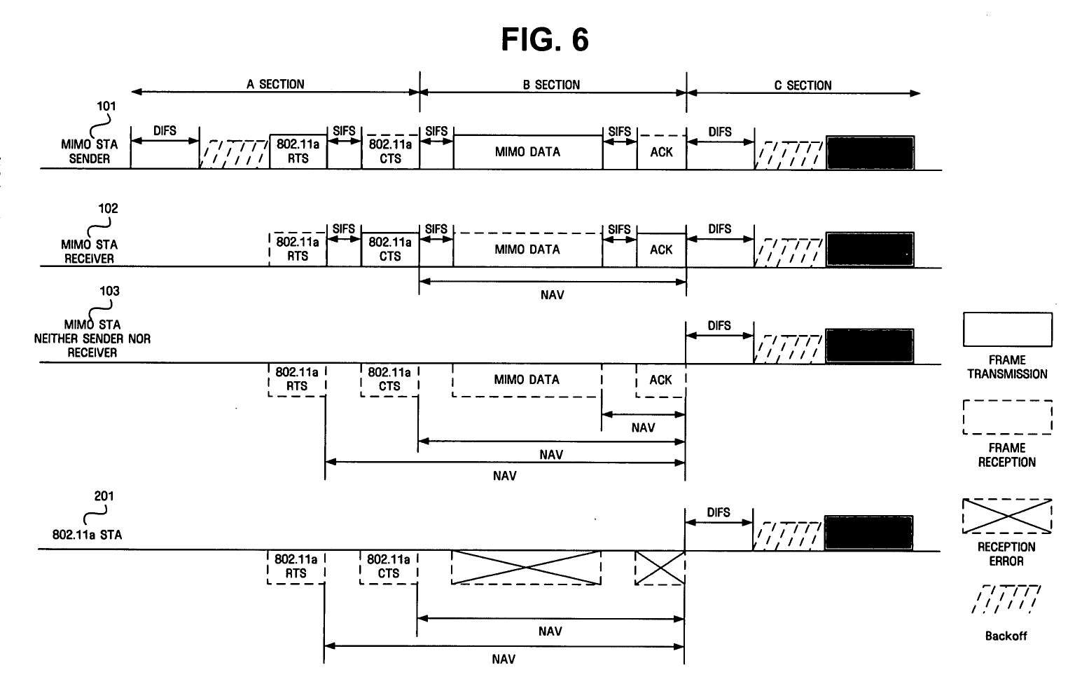

If the coexistence type field 550 has a value of ‘10’, it indicates that the type of coexistence mechanism to be used in the wireless network is a common RTS/CTS mechanism. In the ‘don't care’ mode, a common RTS/CTS mechanism having a value of ‘10’ can also be used. According to the common RTS/CTS mechanism, a sending station transmits/receives an RTS frame and a CTS frame to/from a receiving station before transmitting data to the receiving station, and other stations in the wireless network set their respective NAV values based on the RTS frame and the CTS frame transmitted between the sending station and the receiving station. The common RTS/CTS mechanism will be described later in detail with reference to FIG. 6.

In the recommended mode or the forced mode, the coexistence mechanism specified in the coexistence type field 550 can be used to prevent data collisions among the stations in the wireless network. The above three coexistence mechanisms are exemplary, and thus, other coexistence mechanisms using frames similar to but different from the ones set forth herein can be adopted.

The reserved bits field 560 is reserved for extending the coexistence parameter set. Specifically, the reserved bits field 560 is reserved for extending the minimum PHY capability field 530, the coexistence mode field 540, or the coexistence type field 550. Additionally, the reserved bits field 560 can contain other information.

FIG. 5 is a diagram illustrating a coexistence mechanism according to an exemplary embodiment of the present invention.

Referring to FIG. 5, a first MIMO station 101 is a sending station that transmits MIMO data, and a second MIMO station 102 is a receiving station that receives the MIMO data transmitted by the first MIMO station 101. In section A, the first MIMO station 101 transmits a CTS frame whose destination is the first MIMO station 101 in an 802.11a system. The second MIMO station 102, a third MIMO station 103, and a SISO station 201 that adopt the 802.11a system recognize the CTS frame transmitted by the first MIMO station 101 and set their respective NAV values based on the recognized CTS frame. In section B, a SIFS begins after the transmission of the CTS frame in section A, and then the first MIMO station 101 transmits MIMO data. The second MIMO station 102 receives the MIMO data transmitted by the first MIMO station 101 and transmits an acknowledgement (ACK) frame. The third MIMO station 103 can interpret the MIMO data transmitted by the first MIMO station 101, and thus, can reset its NAV value when another SIFS begins after the transmission of the MIMO data.

Meanwhile, the SISO station 201 carries out a virtual carrier sensing operation using its NAV value set based on the CTS frame transmitted in the 802.11a system by the first MIMO station 101 in section A, and thus is prevented from transmitting data in section B. As a result, in section B, the first MIMO station 101 can completely transmit the MIMO data to the second MIMO station 102 without causing any data collisions with the SISO station 201. Section C is for transmitting/receiving new data. In section C, one of the first through third MIMO stations 101 through 103 and the SISO station 201 can transmit data.

Operations performed by the various stations shown in FIG. 5 will now be described.

The first MIMO station 101 transmits the CTS frame in the 802.11a system. A SIFS begins after the transmission of the CTS frame, and then the first MIMO station 101 transmits the MIMO data. Subsequently, a SIFS begins after the transmission of the MIMO data, and then the first MIMO station 101 receives the ACK frame transmitted by the second MIMO station 102.

The second MIMO station 102 sets its NAV value based on the CTS frame transmitted by the first MIMO station 101. A SIFS begins after the reception of the CTS frame transmitted by the first MIMO station 101. The second MIMO station 102 then receives the MIMO data transmitted by the first MIMO station 101 and the second MIMO station 102 transmits the ACK frame after a SIFS.

The third MIMO station 103 sets its NAV value based on the CTS frame transmitted by the first MIMO station 101 and is prevented from transmitting data until its NAV value is counted down to 0. When another SIFS begins after the transmission of the MIMO data by the first MIMO station 101, the third MIMO station 103 resets its NAV value, for a time period inclusive of the duration of the ACK frame transmitted by the second MIMO station 102, because it can interpret the MIMO data transmitted by the first MIMO station 101.

The SISO station 201 can also set its NAV value based on the CTS frame transmitted by the first MIMO station 101. Since the CTS frame is transmitted in the 802.11a system by the first MIMO station 101, the SISO station 201 can recognize it. However, the SISO station 201 cannot interpret the MIMO data transmitted in section B by the first MIMO station 101. Thus, the SISO station 201 assumes that the medium is occupied for the time being based on its NAV value.

According to the common CTS mechanism illustrated in FIG. 5, a MIMO station and a SISO station can coexist in a wireless network without data collision there between. However, the common CTS mechanism may have a problem with hidden nodes. For example, a CTS frame transmitted by a sending MIMO station may not be received by a SISO station. In order to solve this problem, instead of the common CTS mechanism, the common RTS/CTS mechanism is used.

FIG. 6 is a diagram illustrating a coexistence mechanism according to another exemplary embodiment of the present invention.

Referring to FIG. 6, a first MIMO station 101 is a sending station that transmits MIMO data, and a second MIMO station 102 is a receiving station that receives the MIMO data transmitted by the first MIMO station 101. In section A, the first MIMO station 101 transmits an RTS frame in an 802.11a system. The second MIMO station 102 receives the RTS frame transmitted by the first MIMO station 101 and transmits a CTS frame in the 802.11a system as a response to the received RTS frame.

After recognizing that the RTS frame and the CTS frame have been transmitted between the first and second MIMO stations 101 and 102 in a wired network, a third MIMO station 103 and a SISO station 201 set their respective NAV values based on the RTS frame and the CTS frame. In other words, the second MIMO station 102, the third MIMO station 103 and the SISO station 201 set their respective NAV values when the first MIMO station 101 transmits the RTS frame to the second MIMO station 102 in the 802.11a system and reset their respective NAV values when the second MIMO station 102 transmits the CTS frame to the first MIMO station 101 in the 802.11a system. Since the RTS frame and the CTS frame are transmitted between the first and second MIMO stations 101 and 102 in the 802.11a system, the SISO station 201, which adopts the 802.11a system, can recognize the RTS frame and the CTS frame.

In section B, a SIFS begins after the transmission of the CTS frame, and the first MIMO station 101 transmits MIMO data. The second MIMO station 102 receives the MIMO data transmitted by the first MIMO station 101 and transmits an ACK frame. The third MIMO station 103 can interpret the MIMO data transmitted by the first MIMO station 101, and thus, it can reset its NAV value for a time period which includes the duration of the ACK frame transmitted by the second MIMO station 102 when a SIFS begins after the transmission of the MIMO data by the first MIMO station 101.

The SISO station 201 sets its NAV value based on the RTS frame and the CTS frame transmitted between the first and second MIMO stations 101 and 102 in the 802.11a system, and thus, it is prevented from transmitting data in section B. As a result, in section B, the first MIMO station 101 can completely transmit the MIMO data to the second MIMO station 102 without causing any data collisions with the SISO station 201. Section C is for transmitting/receiving new data. In section C, one of the first through third MIMO stations 101 through 103 and the SISO station 201 can transmit data.

Operations performed by the various stations shown in FIG. 6 will now be described.

In short, the first MIMO station 101 transmits the RTS frame in the 802.11a system. A SIFS begins after the transmission of the RTS frame, and the first MIMO station 101 receives the CTS frame transmitted by the second MIMO station 102 in the 802.11a system. Subsequently, a SIFS begins after the reception of the CTS frame, and the first MIMO station 101 transmits the MIMO data. A SIFS begins after the transmission of the MIMO data, and then the first MIMO station 101 receives the ACK frame transmitted by the second MIMO station 102.

The second MIMO station 102 receives the RTS frame transmitted by the first MIMO station 101. A SIFS begins after the reception of the RTS frame, and the second MIMO station 102 transmits the CTS frame. Subsequently, a SIFS begins after the transmission of the CTS frame, and the second MIMO station 102 receives the MIMO data transmitted by the first MIMO station 101. A SIFS also begins after the reception of the MIMO data, and then the second MIMO station 102 transmits the ACK frame.

The third MIMO station 103 sets its NAV value based on the RTS frame and the CTS frame transmitted between the first and second MIMO stations 101 and 102, and thus, it is prevented from transmitting data until its NAV value is counted down to 0. When a SIFS begins after the transmission of the MIMO data by the first MIMO station 101, the third MIMO station 103 resets its NAV value for a time period which includes the duration of the ACK frame transmitted by the second MIMO station 102 because it can interpret the MIMO data transmitted by the first MIMO station 101.

The SISO station 201 can also set its NAV value based on the RTS frame and the CTS frame transmitted between the first and second MIMO stations 101 and 102. Since the RTS frame and the CTS frame are transmitted between the first and second MIMO stations 101 and 102 in the 802.11a system, the SISO station 201 can recognize both. However, the SISO station 201 cannot interpret the MIMO data transmitted in section B by the first MIMO station 101. Thus, the SISO station 201 assumes that the medium is occupied for a time period based on its NAV value set with reference to the CTS frame.

Meanwhile, the problem with hidden nodes, which may occur in the common CTS mechanism shown in FIG. 5, can be solved by the common RTS/CTS mechanism. This is because, even when a predetermined node in a wireless network where an AP exists fails to receive an RTS frame, it still can set its NAV value based on a CTS frame transmitted via the AP by a node that has received the RTS frame.

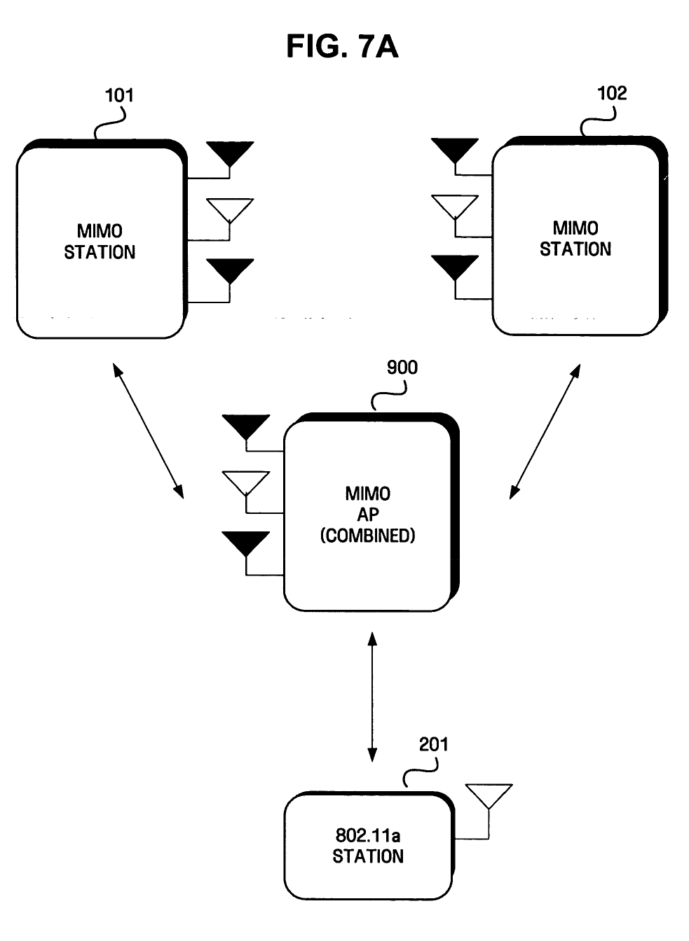

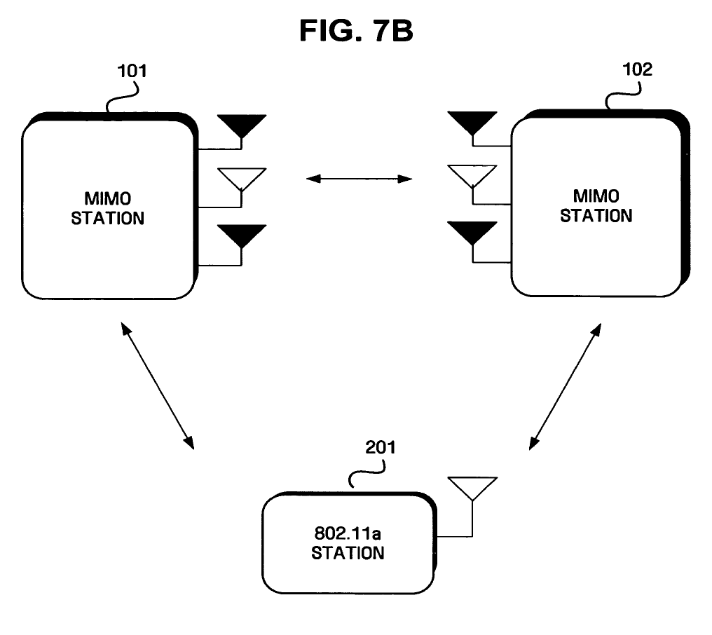

FIGS. 7A and 7B are diagrams illustrating the structures of networks according to exemplary embodiments of the present invention.

Specifically, FIG. 7A is a diagram illustrating an infrastructure network including MIMO stations 101 and 102 and a SISO station 201. Referring to FIG. 7A, the MIMO stations 101 and 102 and the SISO station 201 communicate with one another via an AP 900. When using the common CTS mechanism, a sending MIMO station transmits a CTS frame in an 802.11a system, so the SISO station 201, which adopts the 802.11a system, recognizes the CTS frame and thus sets its NAV value with reference to the CTS frame.

When using the common RTS/CTS mechanism, the sending MIMO station transmits an RTS frame. The RTS frame transmitted by the sending MIMO station is transmitted to a receiving MIMO station via the AP 900, and a CTS frame transmitted by the receiving MIMO station is transmitted to the sending MIMO station via the AP 900. Accordingly, even when the SISO station 201 fails to recognize the RTS frame transmitted by the MIMO station, it still can recognize the CTS frame transmitted via the AP 900, and thus, it can set its NAV value with reference to the CTS frame.

FIG. 7B is a diagram illustrating an ad-hoc network (i.e., an independent network) including MIMO stations 101 and 102 and a SISO station 201. Referring to FIG. 7B, the MIMO stations 101 and 102 transmit data to and receive data from each other without the aid of an AP. When using the common CTS mechanism, a sending MIMO station transmits a CTS frame in an 802.11a system. The SISO station 201, which adopts the 802.11a system, recognizes the CTS frame transmitted by the sending MIMO station and sets its NAV value based on the received CTS frame.

In addition, when using the common RTS/CTS mechanism, the sending MIMO station transmits an RTS frame. The RTS frame transmitted by the sending MIMO station is received by a receiving MIMO station, and the receiving MIMO station transmits a CTS frame to the sending MIMO station in response to the received RTS frame. Accordingly, even if the SISO station 201 cannot recognize the RTS frame transmitted by the sending MIMO station, it still can set its NAV value based on the CTS frame transmitted by the receiving MIMO station.

The common CTS mechanism and the common RTS/CTS mechanism are carried out before one station transmits data to another. Accordingly, in a wireless network where no SISO stations exist or where SISO stations do not transmit data, the common CTS mechanism or the common RTS/CTS mechanism may be optionally carried out. In addition, the common CTS mechanism or the common RTS/CTS mechanism may be carried out depending on whether the problem with hidden nodes is likely to arise in a network. In this case, it is determined whether to use the common CTS mechanism or the common RTS/CTS mechanism based on the coexistence parameter set of FIG. 4A.

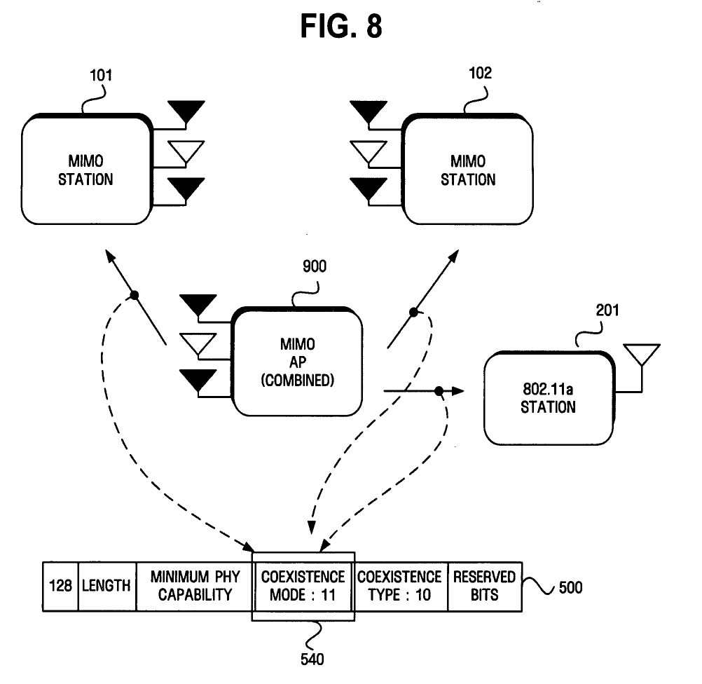

FIG. 8 is a diagram illustrating the modifying of a coexistence parameter set 500 in consideration of a network environment and the sending of the modified coexistence parameter set 500 according to an exemplary embodiment of the present invention.

In the network illustrated in FIG. 8, a SISO station 201 exists and neither transmits data nor receives data for a predetermined period. Since the SISO station 201 is expected not to transmit/receive data for the predetermined period, there is no need to carry out a coexistence mechanism for performing a virtual carrier sensing operation on the SISO station 201. Therefore, an AP 900 sets the coexistence mode field 540 of the coexistence parameter set 500 to a value of ‘11’ (the ‘don't use’ mode) so that no coexistence mechanism is carried out. If the SISO station 201 attempts to transmit data and data collisions occur in the network, the AP 900 resets the coexistence mode field 540 of the coexistence parameter set 500 to a value of ‘00’ (the ‘don't care’ mode), ‘01’ (the forced mode), or ‘10’ (the recommended mode) depending on the circumstances in the network.

In short, in a network where SISO stations exist but transmit very little or no data, using a coexistence mechanism may adversely affect the performance of the entire network. Thus, the coexistence mechanism may be optionally used depending on the circumstances in the network, thereby reducing overhead related to the transmission or reception of data in the network.

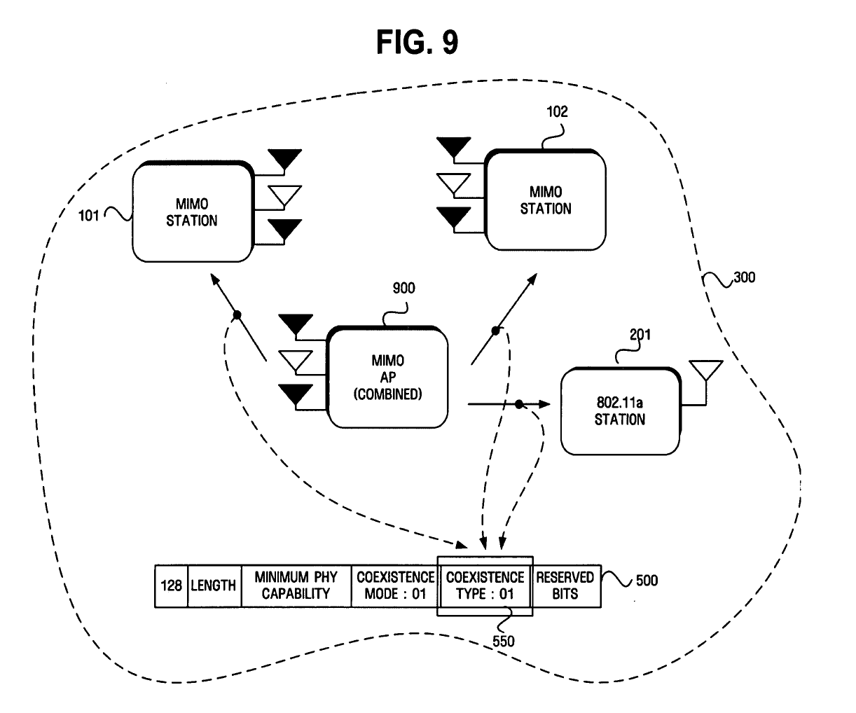

FIG. 9 is a diagram illustrating the modifying of a coexistence parameter set 500 in consideration of a network environment and the sending of the modified coexistence parameter set 500 according to another exemplary embodiment of the present invention.

Referring to FIG. 9, no hidden nodes exist in the wireless network, and the coexistence parameter set 500 is modified and then transmitted.

A wireless communication zone 300 covers all the stations included in the wireless network, i.e., MIMO stations 101 and 102 and a SISO station 201. In this case, the common RTS/CTS mechanism does not need to be carried out. Since there are no hidden nodes in the network, the SISO station 201 can successfully carry out a virtual carrier sensing operation using the common CTS mechanism. Therefore, an AP 900 sets a coexistence type field 550 of the coexistence parameter set 500 to a value of ‘01’ (the common CTS mechanism) so that data collisions that may occur in the network are prevented using the common CTS mechanism. If a station other than the MIMO stations 101 and 102 and the SISO station 201 enters the wireless communication zone 300, the AP 900 may reset the coexistence type field 550 of the coexistence parameter set 500 to a value of ‘10’ (the common RTS/CTS mechanism) after considering the probability that the station most recently entering the wireless communication zone 300 will become a hidden node.

In addition, as previously shown in FIG. 8, even if the station that has recently joined the wireless communication zone 300 is a SISO station and is highly likely to become a hidden node in view of a propagation zone of the MIMO stations 101 and 102, the AP 900 may not reset the coexistence type field 550 of the coexistence parameter set 500 to a value of ‘10’.

In short, as described above with reference to FIGS. 8 and 9, the coexistence mode field 540 and the coexistence type field 550 of the coexistence parameter set 500 may be adjusted depending on the circumstances in a network and the way stations in the network communicate with each other.

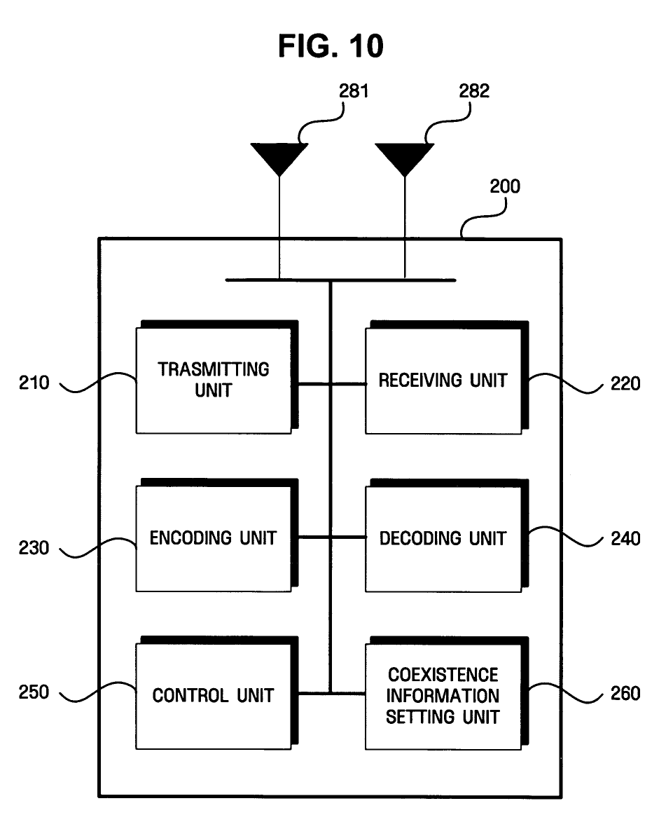

FIG. 10 is a block diagram illustrating a MIMO station 200 according to an exemplary embodiment of the present invention.

In this embodiment, the term ‘unit’, that is, ‘module’, as used herein, means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a communication system.

Referring to FIG. 10, the MIMO station 200 includes a transmitting unit 210, a receiving unit 220, an encoding unit 230, a decoding unit 240, a control unit 250, a coexistence information setting unit 260, and at least two antennas 281 and 282. The structure of the MIMO station 200 illustrated in FIG. 10 realizes the embodiments of the present invention illustrated in FIGS. 3 through 9.

The antennas 281 and 282 receive and transmit wireless signals.

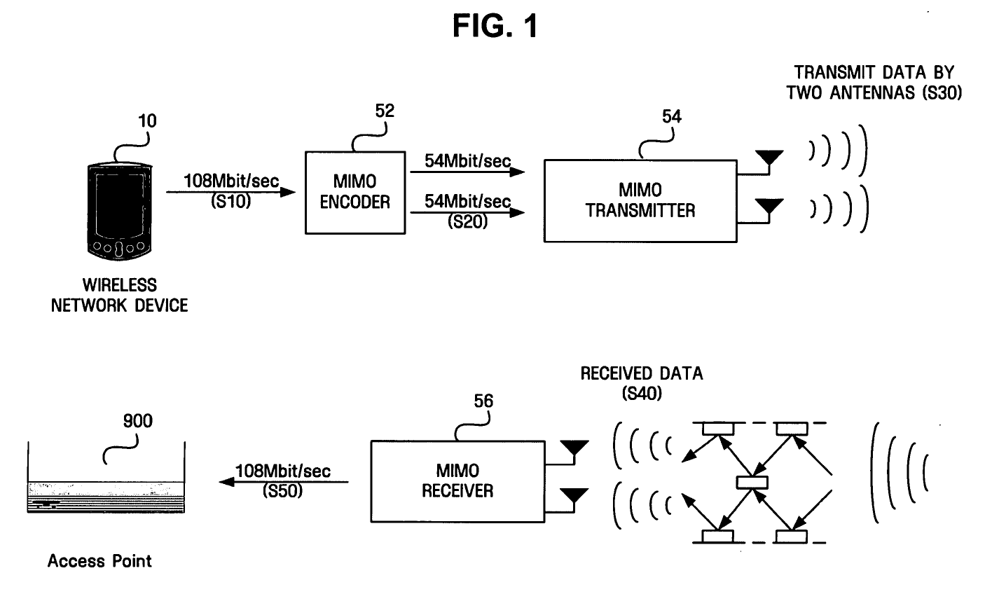

The transmitting unit 210 transmits signals to the antennas 281 and 282, and the encoding unit 230 encodes data to generate signals to be transmitted to the antennas 281 and 282 by the transmitting unit 210. In order to transmit signals via two or more antennas, the signal data must be divided and then encoded separately. That is to say, encoding operations, which correspond to operations S10 and S20 previously shown in FIG. 1, are performed at a rate of 108 Mbit/sec is divided into first data and second data, and the first and second data are encoded separately from each other. The first and second encoded data are then transmitted at a rate of 54 Mbit/sec.

The receiving unit 220 receives signals from the antennas 281 and 282, and the decoding unit 240 decodes the signals received by the receiving unit 220 into data. When receiving signals from two or more antennas, it is necessary to integrate the received signals.

The coexistence information setting unit 260 may generate coexistence information based on information received from other stations when the MIMO station 200 serves as an AP or transmits a beacon frame or a probe response frame in an ad-hoc network. If the MIMO station 200 serves only the functions of a typical MIMO station, the coexistence information setting unit 260 may store coexistence information received from an AP or other stations in an ad-hoc network and thus prevent the MIMO station 200 from being involved in any data collisions with other stations when transmitting MIMO data.

The coexistence information setting unit 260 carries out a predetermined operation for preventing data collisions between a sending MIMO station and other stations before the sending MIMO stations attempts to transmit MIMO data. In addition, an AP or a station in an ad-hoc network that transmits a management frame, such as a beacon frame, may decide which coexistence mode or coexistence mechanism to use based on the current network environment and the states of the stations in the current network environment.

The control unit 250 manages and controls the exchange of information among the other elements of the MIMO station 200.

As described above, according to the present invention, a multi-input multi-output (MIMO) station and a single input single output (SISO) station can coexist in a wireless network without data collision occurring.

In addition, according to the present invention, it is possible to enhance the data transmission efficiency of the wireless network by preventing the SISO station from transmitting data when the MIMO station transmits data.

It will be understood by those of ordinary skill in the art that various changes in form and details may be made herein without departing from the spirit and scope of the present invention as defined by the following claims. Therefore, the above described exemplary embodiments are for purposes of illustration only and are not to be construed as a limitation of the invention. The scope of the invention is given by the appended claims, rather than the preceding description, and all variations and equivalents which fall within the range of the claims are intended to be embraced herein.

What is claimed is:

1. A method of enabling a multi-input multi-output (MIMO) station and a single input single output (SISO) station to coexist in a wireless network, the method comprising:
receiving information pertaining to a station when the station accesses a wireless network;
setting coexistence information by comparing a number of antennas of the station accessing the wireless network with a number of antennas of a plurality of stations constituting the wireless network; and
transmitting a first frame containing the coexistence information to the plurality of stations constituting the wireless network.

2. The method of claim 1, wherein the wireless network is based on one of the IEEE 802.11a, the IEEE 802.11b standard, and the IEEE 802.11g standard.

3. The method of claim 1, wherein the first frame is a beacon frame or a probe response frame.

4. The method of claim 1, wherein the coexistence information comprises minimum physical layer capability information pertaining to the station accessing the wireless network.

5. The method of claim 4, wherein the minimum physical layer capability information comprises information pertaining to a minimum number of antennas of the plurality of stations constituting the wireless network.

6. The method of claim 1, wherein the coexistence information comprises information on a coexistence mode, which is a mode where a coexistence mechanism is used to prevent data collisions among the plurality of stations constituting the wireless network.

7. The method of claim 6, wherein the coexistence mode is one of a ‘don't care’ mode, a forced mode, a recommended mode, and a ‘don't use’ mode.

8. The method of claim 1, wherein the coexistence information comprises coexistence type information, and the coexistence type information specifies which coexistence mechanism is to be used in the wireless network to prevent data collisions among the plurality of stations constituting the wireless network.

9. The method of claim 8, wherein the coexistence mechanism is one of a ‘don't care’ mode, a common clear to send (CTS) mode, which uses a CTS frame, and a common request to send RTS and a CTS (RTS/CTS) mode, which uses both an RTS frame and a CTS frame.

10. The method of claim 1, wherein after the transmitting of the first frame containing the coexistence information, further comprising modifying the coexistence information, adding the modified coexistence information to a second frame, and transmitting the second frame if changes are made to the plurality of stations constituting the wireless network.

11. The method of claim 1, wherein after the transmitting of the first frame containing the coexistence information, further comprising modifying the coexistence information, adding the modified coexistence information to a second frame, and transmitting the second frame if one or more SISO stations of the plurality of stations do not transmit data for a predetermined period of time.

12. The method of claim 1, after the transmitting of the first frame containing the coexistence information, further comprising modifying the coexistence information, adding the modified coexistence information to a second frame, and transmitting the second frame if there are no hidden nodes among one or more SISO stations of the plurality of stations.

13. A method of enabling a MIMO station and a SISO station to coexist in a wireless network, the method comprising:
allowing a first MIMO station among a plurality of stations constituting a wireless network to receive a first frame containing coexistence information of other stations among the plurality of stations constituting the wireless network;
allowing the first MIMO station to transmit a second frame whose destination is the first MIMO station in a SISO system if the coexistence information indicates that at least one station among the plurality of stations is a SISO station; and
allowing the first MIMO station to transmit MIMO data to a second MIMO station, among the plurality of stations, in a MIMO system.

14. The method of claim 13, wherein the wireless network is based on one of the IEEE 802.11a standard, the IEEE 802.11b standard, and the IEEE 802.11g standard.

15. The method of claim 13, wherein the first frame is a beacon frame or a probe response frame.

16. The method of claim 13, wherein the coexistence information comprises minimum physical layer capability information pertaining to a station accessing the wireless network.

17. The method of claim 16, wherein the minimum physical layer capability information comprises information pertaining to a minimum number of antennas of the plurality of stations constituting the wireless network.

18. The method of claim 13, wherein the coexistence information comprises information pertaining to a coexistence mode, which is a mode where a coexistence mechanism is used to prevent data collisions among the plurality of stations constituting the wireless network.

19. The method of claim 18, wherein the coexistence mode is one of a ‘don't care’ mode, a forced mode, a recommended mode, and a ‘don't use’ mode.

20. The method of claim 13, wherein the coexistence information comprises coexistence type information, and the coexistence type information specifies which coexistence mechanism is to be used in the wireless network to prevent data collisions among the plurality of stations constituting the wireless network.

21. The method of claim 13, wherein the second frame is a clear to send (CTS) frame.

22. A method of enabling a MIMO station and a SISO station to coexist in a wireless network, the method comprising:
allowing a first MIMO station among a plurality of stations constituting a wireless network to receive a first frame containing coexistence information of other stations among the plurality of stations constituting the wireless network;
allowing the first MIMO station to transmit a second frame to a second MIMO station among the plurality of stations in a SISO system if the coexistence information indicates that at least one station among the plurality of stations is a SISO station;
allowing the first MIMO station to receive a third frame transmitted in the SISO system by the second MIMO station; and
allowing the first MIMO station to transmit MIMO data to the second MIMO station in a MIMO system.

23. The method of claim 22, wherein the wireless network is based on one of the IEEE 802.11a standard, the IEEE 802.11b standard, and the IEEE 802.11g standard.

24. The method of claim 22, wherein the first frame is a beacon frame or a probe response frame.

25. The method of claim 22, wherein the coexistence information comprises minimum physical layer capability information pertaining to a station accessing the wireless network.

26. The method of claim 25, wherein the minimum physical layer capability information comprises information on a minimum number of antennas of the plurality of stations constituting the wireless network.

27. The method of claim 22, wherein the coexistence information comprises information pertaining to a coexistence mode, which is a mode where a coexistence mechanism is used to prevent data collisions among the plurality of stations constituting the wireless network.

28. The method of claim 27, wherein the coexistence mode is one of a ‘don't care’ mode, a forced mode, a recommended mode, and a ‘don't use’ mode.

29. The method of claim 22, wherein the coexistence information comprises coexistence type information, and the coexistence type information specifies which coexistence mechanism is to be used in the wireless network to prevent data collisions among the plurality of stations constituting the wireless network.

30. The method of claim 22, wherein the second frame is a request to send (RTS) frame.

31. The method of claim 22, wherein the third frame is a clear to send (CTS) frame.

32. A network device comprising:
a receiving unit, which receives information pertaining to a station when the station accesses a wireless network;
a coexistence information setting unit, which sets coexistence information by comparing a number of antennas of the station accessing the wireless network with a number of antennas of a plurality of stations constituting the wireless network and stores the coexistence information; and
a transmitting unit, which transmits a first frame containing the coexistence information to the plurality of stations constituting the wireless network.

33. The network device of claim 32 further comprising a decoding unit, which decodes signals received by the receiving unit.

34. The network device of claim 32 further comprising an encoding unit, which encodes signals to be transmitted by the transmitting unit.

35. The network device of claim 32, wherein the wireless network is based on one of the IEEE 802.11a standard, the IEEE 802.11b standard, and the IEEE 802.11g standard.

36. The network device of claim 32, wherein the first frame is a beacon frame or a probe response frame.

37. The network device of claim 32, wherein the coexistence information comprises minimum physical layer capability information pertaining to the station accessing the wireless network.

38. The network device of claim 37, wherein the minimum physical layer capability information comprises information pertaining to a minimum number of antennas of the plurality of stations constituting the wireless network.

39. The network device of claim 32, wherein the coexistence information comprises information on a coexistence mode, which is a mode where a coexistence mechanism is used to prevent data collisions among the plurality of stations constituting the wireless network.

40. The network device of claim 32, wherein the coexistence information comprises coexistence type information, and the coexistence type information specifies which coexistence mechanism is to be used in the wireless network to prevent data collisions among the plurality of stations constituting the wireless network.

41. The network device of claim 32, wherein if changes are made to the stations constituting the wireless network after the transmitting unit transmits the first frame containing the coexistence information, the coexistence information setting unit modifies the coexistence information and adds the modified coexistence information to a modified frame, and the transmitting unit transmits the modified frame.

42. The network device of claim 32, wherein if one or more SISO stations of the plurality of stations do not transmit data for a predetermined period of time after the transmitting unit transmits the first frame containing the coexistence information, the coexistence information setting unit modifies the coexistence information and adds the modified coexistence information to a modified frame, and the transmitting unit transmits the modified frame.

43. The network device of claim 32, wherein if there are no hidden nodes among one or more SISO stations of the plurality of stations after the transmitting unit transmits the first frame containing the coexistence information, the coexistence information setting unit modifies the coexistence information and adds the modified coexistence information to a modified frame, and the transmitting unit transmits the modified frame.

44. A network device comprising:
a receiving unit, which receives, from a wireless network, a first frame containing coexistence information pertaining to a plurality of stations constituting the wireless network;
a coexistence information setting unit, which stores the coexistence information contained in the received first frame; and
a transmitting unit, which transmits a second frame to a MIMO station of the plurality of stations in a SISO system if the coexistence information contained in the first frame indicates that at least one station of the plurality of stations is a SISO station, and
wherein a destination of the second frame is the network device.

45. The network device of claim 44, further comprising a decoding unit, which decodes signals received by the receiving unit.

46. The network device of claim 44, further comprising an encoding unit, which encodes signals to be transmitted by the transmitting unit.

47. The network device of claim 44, wherein the wireless network is based on one of the IEEE 802.11a standard, the IEEE 802.11b standard, and the IEEE 802.11g standard.

48. The network device of claim 44, wherein the first frame is a beacon frame or a probe response frame.

49. The network device of claim 44, wherein the coexistence information comprises minimum physical layer capability information pertaining to a station accessing the wireless network.

50. The network device of claim 49, wherein the minimum physical layer capability information comprises information pertaining to a minimum number of antennas of the plurality of stations constituting the wireless network.

51. The network device of claim 44, wherein the coexistence information comprises information pertaining to a coexistence mode, which is a mode where a coexistence mechanism is used to prevent data collisions among the plurality of stations constituting the wireless network.

52. The network device of claim 44, wherein the coexistence information comprises coexistence type information, and the coexistence type information specifies which coexistence mechanism is to be used in the wireless network to prevent data collisions among the plurality of stations constituting the wireless network.

53. The network device of claim 44, wherein the second frame is a clear to send (CTS) frame.

54. A network device comprising:
a receiving unit, which receives, from a wireless network, a first frame containing coexistence information pertaining to a plurality of stations constituting the wireless network; and
a transmitting unit, which transmits a second frame to a MIMO station of the plurality of stations in a SISO system if the coexistence information contained in the received first frame indicates that at least one station of the plurality of stations is a SISO station, wherein the receiving unit receives a third frame transmitted by the MIMO station, and the transmitting unit transmits data to the MIMO station in a MIMO system.

55. The network device of claim 54, further comprising a decoding unit, which decodes signals received by the receiving unit.

56. The network device of claim 54, further comprising an encoding unit, which encodes signals to be transmitted by the transmitting unit.

57. The network device of claim 54, wherein the wireless network is based on one of the IEEE 802.11a standard, the IEEE 802.11b standard, and the IEEE 802.11g standard.

58. The network device of claim 54, wherein the first frame is a beacon frame or a probe response frame.

59. The network device of claim 54, wherein the coexistence information comprises minimum physical layer capability information pertaining to a station accessing the wireless network.

60. The network device of claim 59, wherein the minimum physical layer capability information comprises information pertaining to a minimum number of antennas of the plurality of stations constituting the wireless network.

61. The network device of claim 54, wherein the coexistence information comprises information pertaining to a coexistence mode, which is a mode where a coexistence mechanism is used to prevent data collisions among the plurality of stations constituting the wireless network.

62. The network device of claim 54, wherein the coexistence information comprises coexistence type information, and the coexistence type information specifies which coexistence mechanism is to be used in the wireless network to prevent data collisions among the plurality of stations constituting the wireless network.

63. The network device of claim 54, wherein the second frame is a request to send (RTS) frame.

64. The network device of claim 54, wherein the third frame is a clear to send (CTS) frame.
